(19) United States
(12) Patent Application Publication
(10) Pub. No.: US 2026/0176202 A1
(43) Pub. Date: Jun. 25, 2026

(54) A PARTICULATE MATERIAL AND METHOD FOR MANUFACTURING MATERIALS FOR CEMENT PRODUCTION

(71) Applicant: MAGSORT OY, Helsinki (FI)

(72) Inventors: Niklas TÖRNKVIST, Helsinki (FI); Iva TSENOVA, Helsinki (FI); Sami LIPONKOSKI, Helsinki (FI)

(21) Appl. No.: 19/128,888

(22) PCT Filed: Nov. 9, 2023
(86) PCT No.: PCT/FI2023/050620

§ 371 Date: May 9, 2025

(30) Foreign Application Priority Data
Nov. 10, 2022 (FI) 20226012
Mar. 17, 2023 (FI) 20235315

(51) Int. Cl. C04B 28/02; C04B 7/02; C04B 18/08; C04B 22/06

(52) U.S. Cl. CPC C04B 28/02; C04B 7/02; C04B 18/08; C04B 22/064

(57) ABSTRACT

A particulate material is used as an active agent for reducing chromium(VI) to chromium(III) in manufacture of cement, concrete or the like. The particulate material originates from an industrial pyrometallurgical process, preferably from a steelmaking process, and includes at least 10 weight-% of iron(II) and/or iron(III), given as Fe2O3, calculated from the dry weight of the particulate material, and preferably 5 weight-% or less, more preferably 3 weight-% or less, of Fe(0). A method is for manufacturing a particulate material which is suitable for use as an active agent for reducing chromium(VI) to chromium(III) in a manufacture of cement, concrete or the like.

The present invention relates to a use of a particulate material originating from a pyrometallurgical process. The present invention further relates to a method for reducing chromium(VI) to chromium(III) in manufacture of cement, concrete or the like, as well as to a method for manufacturing materials for cement production according to the preambles of the enclosed independent claims.

### BACKGROUND

Steelmaking slag is one of the major by-products in steel, stainless-steel and carbon steel production. It is essential to find uses for all various by-products of industrial processes, including steelmaking slag. This far, steelmaking slag has found uses as filler material in various applications, such as coarse aggregates for asphalt, aggregates in concrete production and in making slag phosphate fertilisers. However, new economical methods for upgrading steelmaking slag into valuable products are needed to harness the full potential of this industrial by-product.

Not only steelmaking, but pyrometallurgical industry in general produces large amounts of by-products which contain calcium, silica and aluminium oxides. As alternatives for limestone, these industrial by-products could be used as raw materials in cement production. However, these by-products often contain high amount of iron oxides, which melt in the cement kiln and cause disturbances in kiln operation as well as in later process stages of cement production. For example, the raw steelmaking slag may contain up to 35% of iron oxides. By-products from pyrometallurgical industry may also contain metallic particles which cannot be ground to the required particle size. Therefore the use of by-products from pyrometallurgical industry is limited for production of cement clinker.

Steelmaking slag, as well as by-products from other pyrometallurgical processes, are today produced in vast amounts. Therefore, there is a need to develop a more viable methods and uses for upgrading steelmaking slag and the like to valuable products that are produced in high volumes. At the moment, the separation of the different components of the steelmaking slag is a challenging and energy consuming process. The mineral composition of steelmaking slag is crystalline, and it contains various amounts of valuable metallic steel and other metallic particles. The hard crystal matrix of the minerals combined with the hard metal particles in the slag makes grinding of the slag difficult and thus the selective separation of the components not effective, which has limited the viability of upgrading steelmaking slag.

Common cement is made from cement clinker and supplementary cementitious materials. Cement clinker is produced in a cement kiln by high temperature calcination of Ca, Si, Al and Fe containing natural materials, such as limestone (CaCO₃), clay (SiO₂ and Al₂O₃), and sand (SiO₂). In the cement kiln, a large amount of CO₂ is released due to calcination of limestone (CaCO₃+heat→CaO+CO₂). This makes the cement industry one of the biggest CO₂ emitters in the world. The increasing awareness of climate change compels every industry to view critically their actions and to find new effective ways to reduce carbon dioxide emissions. The application of pyrometallurgical by-products, such as untreated steelmaking slag, as a raw material for clinker would decrease the CO₂ emissions, but due to the high content of chromium and iron, this application has this far been limited or impossible. The iron oxide content in the cement clinker raw mix is regulated and corrected to a level that gives a certain amount of liquid phase during the calcination process in the kiln. The final content of Fe₂O₃ in the clinker is at the maximum level of about 5%.

Furthermore, the possibility to use by-products from pyrometallurgical industry in the production of cement clinker is limited by the presence of traces of undesirable heavy metals, especially chromium. The cement kiln has a highly oxidizing environment, and as a result chromium that is fed into the kiln will at least partly oxidize into a hexavalent chromium which is soluble, carcinogenic, mutagenic and irritant. The hexavalent chromium is formed by high temperature oxidation of trivalent chromium in the clinker kiln. Depending on the raw materials, the total chromium content in the cement clinker could range between 10 ppm and 100 ppm, and some of it is oxidized into Cr(VI). If such cement is mixed with water, any Cr(VI) present will dissolve and cause skin irritation.

Directive 2003/53/EC of the European Parliament and of the Council required the member countries to prohibit, from Jan. 17, 2005, the use and marketing of all cements and preparations containing cement, where the soluble chromium(VI) content, once hydrated, exceeds 2 ppm of the dry weight of the cement. To achieve this limit value, Cr(VI) reducing agents can be added to the cement to reduce the Cr(VI) into insoluble and non-toxic Cr(III). Those reducing agents are based on iron sulphate, tin sulphate, or antimony oxide, where the Fe(II), Sn(II) or Sb(III) ions are precipitating the Cr(VI) into salts. However, these reducing agents are often costly and not broadly available. To minimise the use of reducing agents, typically the total chromium in clinker raw mix shall be minimised and the remaining hexavalent chromium shall be reduced using available reducing agents or materials.

Consequently, there is a need in the cement industry to find methods for providing new materials for cement production that reduce the CO₂ footprint of the produced cement. Furthermore, there is a need for method to provide effective Cr(VI) reducing agents.

### SUMMARY

An object of this invention is to minimise or possibly even eliminate the disadvantages existing in the prior art.

A further object of the precent invention is to find new, technically advantageous use for particulate materials originating from industrial pyrometallurgical processes.

An other object of the present invention is to provide a simple and efficient method for producing an active agent for Cr(VI) reduction to Cr(III) in manufacture of cement, concrete or the like.

These objects are attained with the invention having the characteristics presented below and in the characterising parts of the independent claims. Some preferred embodiments of the invention are presented in the dependent claims.

The embodiments mentioned in this text relate, where applicable, to all aspects of the invention, even if this is not always separately mentioned.

### DETAILED DESCRIPTION

A typical use of a particulate material according to the present invention is as an active agent for reducing chromium(VI) to chromium(III) in manufacture of cement, concrete or the like, wherein the particulate material originates from an industrial pyrometallurgical process, preferably from a steelmaking process, and comprises at least 10 weight-% of iron(II) and/or iron(III), given as Fe₂O₃ and calculated from the dry weight of the particulate material, and preferably 5 weight-% or less, more preferably 3 weight-% or less, even more preferably 1 weight-% or less, of Fe(0).

A typical method according to the present invention for reducing chromium(VI) to chromium(III) in a manufacture of cement, concrete or the like, comprises
obtaining a particulate material originating from an industrial pyrometallurgical process, preferably from a steelmaking process, and comprising at least 10 weight-% of iron(II) and/or iron(III), given as Fe₂O₃ and calculated from the dry weight of the particulate material, and preferably 5 weight-% or less, more preferably 3 weight-% or less, even more preferably 1 weight-% or less, of Fe(0), and
adding the particulate material as an active agent to a cement mix, concrete mix or the like for reducing chromium(VI) to chromium(III).

A typical method according to the present invention for manufacturing a particulate material, suitable for use as an active agent for reducing chromium(VI) to chromium(III) in a manufacture of cement, concrete or the like, comprises
obtaining a starting particulate material originating from an industrial pyrometallurgical process, preferably from a steelmaking process, the starting particulate material comprising iron(II) and/or iron(III), and
fractioning the starting particulate material into at least a first fraction and a second fraction, wherein the first fraction and the second fraction have different content of iron(II) and iron(III), and the second fraction is a particulate material comprising at least 10 weight-% of iron(II) and/or iron(III), given as Fe₂O₃ and calculated from the dry weight of the particulate material and preferably 5 weight-% or less, more preferably 3 weight-% or less, even more preferably 1 weight-% or less, of Fe(0).

Now it has been surprisingly found that particulate material originating from an industrial pyrometallurgical process can be used, even without further treatment, as an active agent for reducing chromium(VI) to chromium(III) in a manufacture of cement, concrete, mortar or the like, when the particulate material comprises at least 10 weight-% of iron(II) and/or iron(III). The particulate material may be used by incorporation, i.e. addition, to provide a dry cement mix, concrete mix or the like. The use according to present invention has several advantages, as it provides valuable use for by-products which otherwise would be usually considered and deposited as a waste. Furthermore, the present invention provides a method with which it is easy and effective to upgrade materials originating from industrial pyrometallurgical processes into particulate materials that can be used as an active agent for reducing chromium(VI) to chromium(III) in manufacture of cement, concrete or the like. The particulate material originating from industrial pyrometallurgical process, preferably steelmaking slag, comprises enough iron compounds to provide effective chromium(VI) reduction to chromium(III). Furthermore, there are indications that the obtained reducing effect is long-lasting and does not significantly fade with time. The use of particulate material may also provide additional benefits such as improved strength effect for the cement, concrete or the like.

The particulate material used in the present invention for reducing chromium(VI) to chromium(III) preferably comprises iron(II) and/or iron(III) in an amount of 15 weight-%, preferably 20 weight-%, more preferably 30 weight-%, given as Fe₂O₃ and calculated from the dry weight of the particulate material. The particulate material may comprise, for example 15-90 weight-% or 20-85 weight-%, typically 20-80 weight-% or 25-70 weight-%, more typically 20-60 weight-% or 30-60 weight-%, of iron(II) and/or iron(III), given as Fe₂O₃ and calculated from the dry weight of the particulate material. The high iron(II) and/or iron(III) amount makes the particulate material effective active agent in reducing chromium(VI) to chromium(III) in manufacture of cement, concrete or the like.

According to one preferable embodiment of the invention the particulate material is used in a dry state, i.e. it is mixed with a cement mix, concrete mix or the like as dry, before or during the cement grinding. Alternatively, the particulate material, as dry, may be added to a finished cement after the cement grinding or prior to cement shipment.

According to one embodiment, the particulate material may be used as an aqueous slurry, for example if it is added to the cement during preparation of concrete or mortar.

According to one preferable embodiment, the particulate material may be used in combination with, i.e. brought into contact with, a proton-donating chemical activator, preferably in form of an acid, more preferably an organic acid. The proton-donating chemical activator can be used as a liquid form or as a dry form. The proton-donating chemical activator increases the solubility of the iron(II), as well as reduces iron(III) to iron(II). In this manner, an appropriate amount of iron(II) is available for reducing chromium(VI) to chromium(III), when the particulate material is used as an active agent in manufacture of cement, concrete or the like. According to one embodiment, the proton-donating chemical activator may be an acid, preferably an organic acid, such as carboxylic acid, which is used in combination with, e.g. mixed, with the particulate material for activation of Fe(II) solubility.

The proton-donating chemical activator is preferably an organic acid, more preferably a carboxylic acid, or its salt, more preferably selected from a group comprising oxalic acid, acetic acid, formic acid, citric acid, tartaric acid, their salts or any of their combinations. Preferably the organic acid may be a dicarboxylic acid, preferably oxalic acid. The proton-donating chemical activator, e.g. acid, may be in liquid or solid form, preferably in solid form. The treatment of particulate material with high iron(II) content with the organic acid accelerates the iron(II) dissolution rate.

According to one embodiment, the particulate material may be used in combination with 0.1-50 weight-%, preferably 0.1-25 weight-%, more preferably 0.1-10 weight-% or 0.5-10 weight-%, of the proton-donating chemical activator, preferably an organic acid, such as a carboxylic acid, its salt or any mixtures thereof, as defined above, calculated from the total weight of the particulate material. For example, the organic acid may be used in amounts of <10 weight-%, calculated from the total weight of the particulate material. The organic acid, such as carboxylic acid, may be used in amount of 0.25-9 weight-% or 0.5-7 weight-%, calculated from the total weight of the particulate material.

According to one embodiment of the invention the proton-donating chemical activator is brought into contact with the particulate material either before, during or after the addition of the particulate material into the cement mix, concrete mix or the like. The particulate material can be first mixed with the proton-donating chemical activator and then added to the cement mix, concrete mix or the like According to one embodiment, the proton-donating chemical activator may be added separately from the particulate material to the cement mix, concrete mix or the like. For example, the particulate material and the proton-donating chemical activator can be added simultaneously but separately to the cement mix, concrete mix or the like. Yet further, the particulate material and the proton-donating chemical activator can be added successively one after another to the cement mix, concrete mix or the like.

According to one embodiment, the proton-donating chemical activator may be mixed with the particulate material before the addition of the particulate material to the cement mix, concrete mix or the like, for activation of Fe(II) solubility. The treatment with the proton-donating chemical activator, such as an acid, preferably an organic acid, in liquid or solid form, before the particulate material is used as the active agent in the cement or concrete production is beneficial for both Cr(VI) reduction and for the physical properties of the cement or concrete. The particulate material may be activated by mixing it with the proton-donating chemical activator, such as an organic acid, in the presence of humidity, e.g. mixing of particulate material with natural humidity with the solid organic acid. In this case the Fe(II) is formed at least on the surfaces of the particles of the particulate material. This is beneficial because when the particulate material is mixed into the cement mix or concrete mix, it will be already activated and not dependent on the pH of the cement/water mixture or concrete mixture, where Cr(VI) dissolves and the reduction to Cr(III) is expected to take place.

The proton-donating chemical activator may be added to a cement mix, concrete mix or the like as dry.

According to one embodiment of the invention the proton-donating chemical activator is combined, i.e. brought into contact, with the particulate material either before, during or after cement grinding. The proton-donating chemical activator can be used as liquid, for example, when the proton-donating chemical activator is added to the cement mix before or during cement grinding. The proton-donating chemical activator can form, for example, a part of an additive used in grinding, e.g. grinding aid. The particulate material may in this case be combined with the proton-donating chemical activator by adding the particulate material to the cement mix either before or during the cement grinding or to the finished cement after the cement grinding. The activation process between the proton-donating chemical activator and the particulate material occurs, when the cement is brought in contact with water to form a mortar or a concrete. The proton-donating chemical activator may also be added in liquid form, either as such or as a part of an additive used for mortars and concrete, during the preparation of mortar or concrete, when the cement is mixed with water.

Some particulate materials originating from industrial pyrometallurgical processes may naturally have a high concentration or amount, i.e. 10 weight-%, of iron(II) and/or iron(III), which makes them suitable for use as active agent for reducing chromium(VI) to chromium(III). If this is not the case, according to one aspect of the present invention it is possible to obtain a starting particulate material originating from an industrial pyrometallurgical process and comprising iron(II) and/or iron(III), and fractioning this starting particulate material in order to provide a fraction particulate material comprising a desired iron(II) and/or iron(III) content, for the use as an active agent for reducing chromium(VI) to chromium(III).

The particulate material can be used in manufacture of cement, concrete or the like in variable amounts, depending on the concentration of chromium(VI) that must be reduced to chromium(III), as well as the iron(II) and iron(III) content of the particulate material. However, one benefit of the present invention is that the composition of the particulate material originating from industrial pyrometallurgical processes, such as steelmaking slag, is usually generally suitable for use in cement, concrete or the like and allows the addition of even large amounts of particulate material, in proportions up to 65 weight-%. A person skilled in the art is able to estimate and/or calculate the required amounts to be used based on the general experience. The particulate material may be used, for example, in amount of 0.5-65 weight-%, typically 1-40 weight-%, often 1-15 weight-% or 1.5-10 weight-%, calculated from the total weight of the cement mix, concrete mix or the like.

Generally, the particulate material used in the present invention, either directly or as a starting particulate material, may be any inorganic slag material that originates from an industrial pyrometallurgical process and comprises iron oxides. In the present context, the term “iron oxides” and “oxides of iron” are used synonymously, and they are fully interchangeable. Both terms refer, if nothing else is indicated, to the oxidation states iron(II) and iron(III), as present in mineral structure of particulate materials and/or slag materials originating from pyrometallurgical processes. In the present context, “iron oxide” refers solely to the oxidation state of iron, irrespective if the iron is associated with the oxygen when present in the mineral structure of particulate material or if it is present as another iron compound.

The particulate material or starting particulate material, originating from pyrometallurgical process, may be selected from ferrous slags, ferroalloy slags, base metal slags, pyrometallurgical tailings, or any of their combinations. The particulate material or starting particulate material may originate from the industrial pyrometallurgical production process of steel, either stainless steel or carbon steel, copper, nickel, or zinc. The particulate material or starting particulate material may be a steelmaking slag selected from basic oxygen furnace slags, electric arc furnace slags, ladle furnace slags, Linz-Donawitz slags (LD slags), open-hearth furnace slags, blast furnace slags, desulphurization slags or any combinations thereof, preferably basic oxygen furnace slags, electric arc furnace slags, ladle furnace slags, Linz-Donawitz slags (LD slags), open-hearth furnace slags or any combinations thereof.

In the present context, the term “steelmaking slag” especially refers to any solid waste or by-product formed in the production of steel, stainless-steel or carbon steel. Steelmaking slag can be, but is not limited to, steel slag, stainless steel slag, carbon-steel slag, basic oxygen furnace (BOF) slag, electric arc furnace (EAF) slag or ladle furnace (LF) slag, or any mixtures thereof. According to one preferable embodiment, the particulate material or starting particulate material is a steelmaking slag selected from basic oxygen furnace slags, electric arc furnace slags, induction furnace slags, Linz-Donawitz slags, ladle furnace slags, or any of their combinations, especially selected from basic oxygen furnace slags, electric arc furnace slags, induction furnace slags or any of their combinations. These slags have been problematic to utilize industrially due to metallic particles and/or their chemical compositions, e.g. heavy metal, especially chromium, content, high iron oxide content and/or calcium oxide content. However, the present invention provides an effective method for converting these slags suitable for use as active agents for reducing chromium(IV) to chromium(III). By suitable grinding and fractioning they may even be used otherwise for production of cement clinker or cement.

According to one embodiment, the particulate material or the starting particulate material may be a mixture of materials, such as slags or slag materials, originating from different industrial pyrometallurgical processes. The materials from different pyrometallurgical processes done at the same production site can be mixed together to form the particulate material or the starting particulate material. It is possible, for example, to mix basic oxygen furnace slag or electric arc furnace slag with blast furnace slag.

The particulate material or starting particulate material used in the present invention and originating from an industrial pyrometallurgical process may be in the form of inorganic mineral particles which comprise iron oxides, i.e. iron in form of oxidation states iron(II) and iron(III), and preferably calcium. Calcium may be present as calcium oxides, calcium silicates, calcium carbonate or as any combination of these, as indicated above. The particulate material or starting particulate material typically comprises calcinated mineral particles which comprise calcium. The particulate material or starting particulate material typically comprises, for example, particles of brownmillerite (Ca₂(Al,Fe)₂O₅), wuestite (FeO) and/or magnetite (FeO*Fe₂O₃). The particulate material used in the invention thus comprises iron oxides, typically both FeO and Fe₂O₃, i.e. the particulate material has an initial iron oxide content, denoting the total iron oxide content, before possible fractioning. The particulate material originating from an industrial pyrometallurgical process may further contain at least oxides of silicon, magnesium and/or aluminium. In case the particulate material originates from production process of copper, nickel, or zinc, it may comprise Fe₂SiO₄. Especially the slag that originates from steel, stainless-steel and carbon steel production, also called steelmaking slag, is a CO₂ free material by itself, containing Ca silicates, Ca aluminates and Ca ferrites, and it is a source for Fe(II) and Fe(III) ions.

The particulate material or the starting particulate material used in the present invention and originating from an industrial pyrometallurgical process, such as a mineral fraction of steelmaking slag, can have the following composition of the main components (in weight-%):
SiO₂ 10-50%, for example 10-30%
Fe₂O₃ 3-35%, for example 10-30%
Cr₂O₃ 0.1-4%, for example 0.1-2.5%
MnO 2-5%, for example 2.5-4%
CaO 15-45%, for example 30-45%
MgO 1-15%, for example 2-10%
Al₂O₃ 1-8%, for example 1.5-6.5%
SO₃ 0.2-2%, for example 0.2-1.5%.

For example, the iron(II) and iron(III) content in the steelmaking slag, used in the present invention, may be in a range from 1-45 weight-%, preferably 3-40 weight-%, more preferably 15-40 weight-% or 20-40 weight-%, given as Fe₂O₃, and calculated from the total dry weight of the slag. In the present application, when iron content is given as Fe₂O₃, it contains both iron(II) compounds and iron(III) compounds, calculated as they would be in form of Fe₂O₃.

The particulate material or the starting particulate material used in the present invention and originating from an industrial pyrometallurgical process, may preferably comprise chromium(III) in an amount of 0.05-5 weight-%, preferably 0.1-4 weight-%, more preferably 0.1-1.5 weight-%, given as Cr₂O₃, calculated from the total dry weight of the particulate material or the starting particulate material.

It is possible to adjust the iron(II) and iron(III) content of the particulate material by fractioning. In this manner, the iron(II) and iron(III) content of the particulate material can be tailored to suit the specific use of reducing chromium(VI) to chromium(III), to suit the specific cement, concrete of the like. The starting particulate material for the fractioning is in form of mineral particles having variable iron(II) and iron(III) content. The starting particulate material is fractioned into at least a first fraction and a second fraction, wherein the first fraction and the second fraction have different content of iron(II) and iron(III). The second fraction is in form of a particulate material comprising at least 10 weight-% of iron(II) and/or iron(III), given as Fe₂O₃ and calculated from the dry weight of the particulate material. This means that the iron(II) and/or iron (III) is enriched in the second fraction, which will form the particulate material to be used as an active agent for reduction of chromium(VI) to chromium(III). Fractioning provides thus means for upgrading different pyrometallurgical particular materials or slags to be suitable for use in chromium(VI) reduction. After the fractioning, the iron(II) and iron(III) content of the second fraction is higher than the initial iron(II) and iron(III) content of the starting particulate material before fractioning. When the starting particulate material is fractioned into a first fraction and a second fraction, the first fraction has a lower iron oxide content than the second fraction, and after the fractioning, the iron oxide content of the first fraction is lower than the initial iron oxide content of the starting particulate material before fractioning. The second fraction may have the total iron oxide content of iron(II) and iron(III) of at least 5 weight-%, preferably at least 15 weight-%, more preferably at least 20 weight-%, more than the initial total iron oxide content in the starting particulate material, calculated from the dry weight.

The number of specific fractions and the size-distribution of the particles in various fractions are not important for carrying out the invention. The first and second fractions are given and discussed here as examples, but it is possible to fraction the starting particulate material into a first, second, third and any successive fractions, if needed. The number of fractions and size-distribution of the particles within the fractions can be designed and planned based on the amount of the starting material, e.g. slag, and the capacities of the separation techniques chosen.

It is possible to use any suitable fractioning method that allows particulate material to be fractioned based on their iron oxide content. The fractioning may comprise one fractioning step or a plurality of fractioning steps, performed by using the same separation technique or different separation techniques, as described below. According to one embodiment, it is possible that the separated fractions are subjected to comminution between the fractioning steps. Any comminution methods described later in connection with the pretreatment step can be used for comminution between the fractioning steps.

According to one embodiment of the invention the starting particulate material may be fractioned into the first fraction and the second fraction by using magnetic separation, density separation, size separation, electrostatic separation, flotation separation, eddy-current separation, gravitational separation and airflow separation, or any combination thereof, preferably by using a magnetic separation. For example, it is possible to separate the first fraction and the second fraction by using density separation. In general, mineral particles rich in iron oxides are heavier than mineral particles with low iron oxide content. This makes it possible to separate the first and second fraction by using conventional density and gravity separator. Alternatively, the first and second fraction can be separated by using size separation. Mineral particles rich in iron oxides are harder than mineral particles with low iron oxide content. Usually they are larger in size after any comminution step, which provides a good basis for size separation or size classification of the first and second fraction.

Preferably the fractioning of the starting particulate material is performed as dry fractioning. According to one embodiment, the starting particulate material may be fractioned by using size separation and/or a magnetic separation. For the magnetic separation any suitable magnetic separation technique can be applied.

According to one preferable embodiment of the invention, it is possible to fraction the starting particulate material into a first fraction and a second fraction by using magnetic separation. The iron(II) and iron(III) content in the first fraction and in the second fraction can be adjusted by magnet strength used. By proper selection of the field intensity, the Fe(II) and Fe(III) oxides can be enriched in separate fractions. In this manner it is possible to tailor the properties of the first fraction to be suitable for production of cement clinker in a cement kiln and the properties of the second fraction to be suitable for use as active agent for Cr(VI) reduction.

According to one preferable embodiment the starting particulate material e.g. crushed slag, may be fractioned by using magnetic separation, for example by using weak magnetic separation. For example, it is possible to use a device for separating weakly magnetic particles, disclosed in EP3283225 and incorporated herein by reference. Magnetic separation provides an effective way to separate the particles with iron oxides from other particles and enrich them into the second fraction. The mineral particles have different magnetic properties depending on their iron oxide content and therefore it is possible to use magnetic separation for separating the first and the second fraction at least partially. The field intensity used in the magnetic separation can be selected according to the required fractioning result and/or the particulate material used. According to one example, the weak magnet used for separation of iron oxide rich particles has a field intensity between 200 and 3000 gauss.

According to one embodiment of the invention it is possible to adjust the distribution of iron oxides between the first fraction and the second fraction by the field intensity used in the magnetic separation. This means that the iron(II) and iron(III) content of the second fraction, as well as of the first fraction, may be adjusted as needed. For example, the magnetic field intensity used in the magnetic separation can be adjusted in accordance with the specific properties of the particulate material and/or the desired iron(II) and iron(III) composition of the first fraction and the second fraction.

Magnetic separation step can be performed before or after any optional classification step(s) as described below. If the magnetic separation step is preceded by a classification and separation step(s), the obtained fractions from the classification and separation steps are subjected to the magnetic separation as individual fractions, i.e. the obtained fractions with different particle size distributions are not mixed before the subsequent magnetic separation step.

In one embodiment of the invention the magnetic separation is performed in two stages or more. The two stages of the magnetic separation can be performed by a first magnetic separation using a weak magnet followed by a second magnetic separation using a strong magnet. The strong magnetic separation can also be performed before the weak magnetic separation. A combination of two strong magnetic separations can also be applied. The strong magnetic separation can be performed using a rare earth magnet, an electromagnet or other type of strong magnet. For example, after the first magnetic separation, one of the collected fractions is optionally subjected to a further magnetic separation stage, obtaining a fraction with Fe(II) bearing particles and a fraction with Fe(III) bearing particles that differ in the iron oxide concentration and state (Fe(II) or Fe(III)). This further magnetic separation stage may be performed using a device and a method for separating weakly magnetic particles according to that disclosed in EP3283225B1. The separation is usually partial because the two mineral fractions cannot be completely separated one from the other.

According to one embodiment, the particulate material may be subjected to non-magnetic separation step in addition or as an alternative to magnetic separation step. The non-magnetic separation may be performed before or after the magnetic separation. The particulate material, e.g. crushed slag, may be subjected to a non-magnetic metal separation step(s). The non-magnetic separation method can be chosen from a list comprising eddy-current separation, gravitational separation, and airflow separation, to separate heavy and light non-magnetic metals. Non-magnetic metal separation step can be performed before or after classification step(s), but after separation crushing. If the non-magnetic separation step is preceded by classification and separation step(s), the obtained fractions are subjected to the non-magnetic separation as individual fractions, i.e. the fractions with different particle sizes are not mixed before the subsequent non-magnetic separation step.

The iron(II) and iron(III) amount in the second fraction in form of the particulate material, after fractioning, may be 15 weight-%, preferably 20 weight-%, more preferably 30 weight-%, given as Fe₂O₃ and calculated from the total dry weight of the particulate material. The total iron oxide content may be, for example, in a range of 15-50 weight-%, preferably 20-45 weight-%, more preferably 30-40 weight-%, given as Fe₂O₃ and calculated from the total dry weight of the particulate material. The iron(II) and iron(III) content in the particulate material varies depending on which pyrometallurgical process the particulate material originates from, and optionally from the fractioning method used.

The high iron(II) content is beneficial for the particulate material when it is used as the active agent for reducing chromium(VI) to chromium(III). The fractioning makes it possible to gain the full benefit of iron(II) oxide in the particulate material. The fractioning can be used to increase the iron(II) oxide content in the second fraction while reducing the amount of unwanted substances, such as free lime and/or periclase (MgO). According to one embodiment of the invention, the particulate material, e.g. the second fraction after fractioning, may comprise at least 5 weight-%, preferably 10 weight-%, more preferably 15 weight-% of iron(II), calculated as FeO from the dry weight of the particulate material. The particulate material may comprise, for example, 5-10 weight-%, preferably 10-15 weight-%, more preferably 15-20 weight-%, of iron(II), calculated as FeO from the dry weight of the particulate material.

It is possible to treat the particulate material with the proton-donating chemical activator, e.g. organic acid either in liquid or solid form, after the fractioning but prior to the possible comminuting.

The particulate material, when used as an active agent, preferably has a particle size Dv90≤200 μm, preferably ≤100 μm, more preferably 550 μm, even more preferably ≤30 μm. The particulate material may have the particle size Dv90 in a range from 3-200 μm, preferably 3-100 μm or 3-50 μm, more preferably 3-30 μm. Particle size Dv90 indicates that 90% of the material in weight is below the given size. In this manner the particle size of the particulate material matches the cement fineness and allows, for example, direct addition of the particulate material into the final cement or concrete. If needed, the particulate material, for example the second fraction after the magnetic fractioning, may be subjected to further fine grinding or comminuting to obtain fine grinded particles. In one embodiment, the fine grinding or comminuting step is performed in a way that ensures that the collected fine non-magnetic minerals containing calcium, silicate, iron and alumina are separated from each other. All grinding and comminuting methods described below in combination with the pretreatment step(s) can be used for fine grinding and comminuting the particular material to the desired particle size Dv90.

The particulate material is added to a cement mix, concrete mix or the like as an active agent for reducing chromium(VI) to chromium(III). The particulate material is preferably added as it is, i.e. dry. The particulate material may be added to a cement mix before or after the cement mill. This means that the particulate material is introduced into the cement production process after the cement kiln. The possible chromium present in the particulate material is form of Cr(III) as it has not been subjected to an oxidative environment. Cr(III) is non-soluble and safe to use, which makes the particulate material well-suited for use as supplementary material for cement production. The particulate material is thus used as a Cr(VI) reducing agent for the production of cement, concrete or the like.

Usually, when excess of Cr(VI) is found in the clinker, ferrous sulphate, tin sulphate or antimony oxide are used to correct it via precipitation with Fe(II), Sn(II) or Sb(III) ions. If fractioning, e.g. by magnetic separation, is used to increase the Fe(II) amount in the particulate material, the particulate material is especially suited to be used as an active hexavalent chromium reducer for the cement, concrete or the like. If particulate material comprising iron(II) oxide is fed into the cement kiln, iron(II) will be oxidized to iron(III) and lose the ability to reduce the soluble Cr(VI). In the present invention this can be avoided by enriching the iron(II) oxide into the particulate material, which bypasses the cement kiln, and is fed at a later stage to the cement mix, concrete mix or the like, where it then will be active as Cr(VI) reducing agent.

The particulate material is especially suitable as an active agent for reducing chromium(VI) to chromium(III) in manufacture of Portland cement, having a preferably general composition of 61-67 weight-% of CaO, 19-23 weight-% of SiO₂, 2.5-6 weight-% of Al₂O₃, 2-5 weight-% of Fe₂O₃ and 1.5-4.5 weight-% of SO₃. Before the addition of the particulate material, the cement mix for Portland cement may comprise 25-60 weight-% of tricalcium silicate, 20-45 weight-% of dicalcium silicate, 5-12 weight-% of tricalcium aluminate, 6-15 weight-% of tetracalcium aluminoferrite and 2-10 weight-% of gypsum. The particulate material can be used in the manufacture of Type I, Type II, Type III, Type IV or Type V of common cement.

According to one embodiment, the particulate material or the starting particulate material may be pretreated in one or more pretreatment steps before the fractioning step or before the particulate material is used as an active agent for chromium(VI) reduction. One pretreatment step may comprise comminuting of the particulate material or starting particulate material originating from an industrial pyrometallurgical process by crushing and/or grinding to liberate the possible metallic particles from the mineral matrix. The material originating from the pyrometallurgical process usually comprises a mineral matrix, where metallic particles may be embedded. For example, stainless-steel slag can typically contain up to 4 to 5 weight-% metallic stainless-steel, which is a valuable product, but which also increases the energy consumption of the fine grinding steps if it is left in the crushed slag.

As such, metallic particles, i.e. Fe(0), does not disturb the reduction of chromium(VI) to chromium(III), but their presence in the cement might lead to processing difficulties, and is generally to be considered as wasteful use of resources. In the present context the expression “metallic particles” generally refers to particles of free metal, such as Fe(0), and particles of alloy, such as steel. The particulate material, when used as an active agent for chromium(VI) reduction preferably contains low amount of metallic particles. The particulate material may comprise 5 weight-% or less, preferably 3 weight-% or less, more preferably 2 weight-% or less, even more preferably 1 weight-% or less, or 0.5 weight-% or less, of metallic particles, i.e. Fe(0). The particulate material may comprise 0-5 weight-%, typically 0.1-3 weight-%, more typically 0.5-2 weight-%, of metallic particles, i.e. Fe(0). Sometimes the particulate material may even comprise 0.1-1 weight-%, of metallic particles, i.e. Fe(0).

Comminution in the pretreatment step can be performed by using any method suitable for liberating metallic particles from the mineral matrix material, including but not limited to milling, grinding, using a vertical or horizontal shaft impact crusher, a rotor centrifugal crusher or any combination thereof. Preferably the comminution is performed as dry comminution. For example, the comminution may be performed by using an impact crusher, a high energy impact crusher, a jaw crusher, a cone crusher, a hammer crusher, a roll crusher, a ball mill, a rod mill, or any combination of these. One preferable comminution method is high energy impact crushing, where the material to be crushed is accelerated to high speed and thrown against moving counter element, wherein the material is broken into particles to liberate the metallic particles from the mineral matrix. The high energy impact crushing brings the material originating from the pyrometallurgical process in a state where the mineral particles, i.e. particulate material, and the metallic particles can be further separated one from the other.

For example, steelmaking slag may first be subjected in a pretreatment step to separation crushing to obtain crushed steelmaking slag, in which the metallic particles and oxides are at least partially liberated from the hard mineral matrix and this process makes their concentration possible, e.g. by using magnetic separation or other suitable separation. Herein the term “separation crushing” means a method, wherein the slag is crushed, i.e. to produce a smaller particle size of a solid material, and the crushing is done with a method that separates metallic particles and the minerals in the slag from each other. The separated minerals, i.e. particulate material or starting particulate material, can contain metals in compound form, for example as calcium silicate, calcium ferrite and brownmillerite. As the crusher, a jaw crusher, a cone crusher, a hammer crusher, an impact crusher, a roll crusher, or the like can be used, and a crusher such as a ball mill or a rod mill may be used. Physically the separation crushing means any method that can produce a separation force that breaks the inclusions (fissures) between metallic steel particles and minerals. One example of separation crushing method is high impact dry crushing according to patent publication FI128329.

In one embodiment, the comminution or separation crushing may be performed with a dry crushing method. In this case, dry crushing means that essentially no water or other liquid is added to the slag before the crushing. Traditionally metallic particles of stainless-steel or the like are separated from the slag through wet grinding which requires adding water or other liquid to the slag before crushing it. As a result of wet grinding, the remaining slag is turned into a wet slurry, which cannot be recycled. A dry crushing method prevents the formation of wet slurry and enables the use of the mineral fraction as particulate material or starting particulate material for providing an active agent for manufacture of cement, concrete or the like. While it is preferable to use a dry crushing method, such as high impact dry crushing, the slag can contain a certain amount of moisture depending on the production of the steel and/or stainless steel as well as the pre-treatment of the slag. In one embodiment, the slag which is subjected to the dry crushing has a moisture content from 2 weight-% to 15 weight-%, preferably from 3 weight-% to 8 weight-%.

The comminution or separation crushing can be performed in one or more than one stages. For example, the comminution or separation crushing of the steelmaking slag is performed in two stages, of which the first dry crushing stage provides coarser particles, which are subjected to a second dry crushing stage, which provides the separated finer particle sizes. The comminution or separation crushing may even be performed in more than two stages, in which each subsequent crushing stage provides finer particles compared to the previous crushing stage. The milling can be performed in at least two stages, of which each can further constitute one or more individual crushing sub-steps.

Further, in the pretreatment step the particulate material or the starting particulate material from the industrial pyrometallurgical process may be comminuted to a particle size Dv50 of ≤10 mm, preferably ≤3 mm or ≤2 mm, more preferably ≤1.5 mm. The particle size Dv50 may be in a range of 0.1-10 mm, preferably 0.2-2 mm, preferably 0.3-1.5 mm, sometimes 0.5-1 mm. Particle size Dv50 indicates that 50% of the material in weight is below the given size. The particle size as used herein is measured according to standards ISO 13320:2020 and ISO 9276-2:2014. The particle size of the particulate material may be adjusted according to the composition of the material and/or to the separation method(s) used for fractioning. When the starting particulate material has the particle size as defined, an effective separation in the fractioning can be achieved. Especially, when the material originating from the pyrometallurgical process may comprise embedded or trapped metallic particles, the particulate material may have preferably a particle size ≤51.5 mm or ≤1.3 mm, in order to avoid damaging cement mill grinding equipment in successive process steps.

Another pretreatment step of material originating for industrial pyrometallurgical process for obtaining the particulate material or the starting particulate material may further comprise separation of metallic particles and/or size classification. The separation of metallic particles may be performed preferably by using a magnetic separation and/or sieving. The separation and/or size classification pretreatment step may be performed either before or after comminuting pretreatment step, described above, or both before and after comminuting pretreatment step. According to one embodiment, after the comminution the pretreatment step comprises a separation of metallic particles from the comminuted particulate material, preferably by using a magnetic separation and/or size classification. If the size classification pretreatment is performed before comminuting pretreatment, it is possible to obtain a fine fraction, having a particle size Dv50<1 mm, and comprising up to 50 weight-%, typically 10-40 weight-%, of total calcium, given as calcium oxide, measured by XRF. In the present context, the expression “calcium” refers, if nothing else is indicated, to the total content of calcium compounds in the form of oxides, hydroxides, silicates, ferrites, aluminates or traces of carbonates, encompassing all chemical compounds of calcium. The total calcium thus comprises all calcium compounds present, including calcium silicates, calcium carbonates, calcium oxides, etc.

For example, the steelmaking slag that has been crushed in the separation crushing step is classified based on the size of the particles. The classification of the crushed slag particles can be performed using any suitable method for sieving or screening the formed particles. The classification or separation based on particle size is done to obtain at least two fractions with different particle sizes. The two fractions can be characterised as small fraction and middle fraction. In one embodiment a large fraction is separated, which can be recycled back to the dry crushing stage.

After the pretreatment step(s), separated metallic particles can be returned or recycled back to the pyrometallurgical process, e.g. steel production. For example, when the material, i.e. slag, originating from basic oxygen furnace or electric arc furnace is comminuted to a particle size Dv50≤2 mm or ≤1.5 mm, most of the metallic particles are in form of large particles having a particle size ≥1.5 mm, i.e. they can be separated by screening or sieving with a screen or sieve having 1.5 mm openings. Metallic particles with small particle size, e.g. with a particle size ≤1.3 mm, passing the screen or sieve are quickly oxidized into iron oxides. Alternatively or in addition, metallic particles can also be separated by using a magnetic separator, known as such, with an adequate magnetic field.

The size distribution of the particles of the particulate material, after the optional pretreatment step(s) and before the optional fractioning, is preferably such that no large metallic particles having a particle size ≥1.5 mm are trapped or embedded within the mineral matrix in the particulate material or the starting particulate material.

The first fraction obtained from the fractioning of the starting particulate material usually has lower iron(II) and iron(III) content, in comparison to the second fraction which forms the particulate material used for the reduction of chromium(VI) to chromium(III). At least a part of the first fraction can be used to form a part of a feed material for producing cement clinker in a cement kiln. This means that the first fraction is used to either replace or supplement the conventional feed materials for cement clinker production. In this context the expression “a feed material for producing cement clinker” encompasses all materials and material combinations or mixtures used for producing cement clinker and introduced to the kiln. The present invention enables separation and concentration of the first and second fractions from the starting particulate material with the aim of using them individually in different steps of the cement production process. This way of treating and using the particular material from a pyrometallurgical process makes it possible to profit from the CO₂ neutrality in addition to the Cr(VI) reduction potential of the material. It has been now surprisingly found that by fractioning the starting particulate material originating from an industrial pyrometallurgical process into a first fraction with a lower iron oxide content and to a second fraction with a higher iron oxide content, it is possible to use larger amounts of material originating from the industrial pyrometallurgical processes as a feed material of the cement kiln. In this way the problems caused by iron oxides in the cement kiln can be avoided. The present invention makes it possible to effectively use materials from industrial pyrometallurgical processes, especially from basic oxygen furnaces and electric arc furnaces, in cement manufacture. This is beneficial as it reduces the need for virgin materials from natural sources that are non-calcinated, i.e. which emit CO₂ in the cement kiln, such as limestone. At the same time, the production per ton of kiln feed material can be increased as the losses from CO₂ release are reduced, and it is possible to reduce the energy consumption of the clinker production process due to partial elimination of the calcination step. It is also possible to obtain lower NOx emissions due to lower flame temperature needed in the cement kiln. Especially, when the materials from industrial pyrometallurgical processes comprise calcium oxides, it is possible to significantly reduce the total CO₂ emissions of cement clinker production. In other words, according to one embodiment of the invention at least a part of the first fraction is introduced into the production process of cement clinker so that it takes part in the chemical reactions forming the clinker. The first fraction can be introduced into the kiln as such or in combination with other raw materials. The first fraction can be used as the only raw material of the feed, or it can be used as a part of a feed with other raw materials. One or more additional ingredients chosen from the list comprising limestone, gypsum, clay, shale, sand, iron ore, bauxite, fly ash, blast furnace (BF) slag can be added to the cement kiln feed. The present invention is thus even able to provide a cost-effective and efficient method for producing material for cement clinker production in a cement kiln.

The fractioning of the starting particulate material allows the adjustment of the iron oxide content between the first fraction and the second fraction, i.e. the method may comprise fractioning the particulate material into a first fraction and a second fraction and adjusting the iron oxide content of the first fraction and the second fraction. Preferably, at the same time the calcium content, such as content of calcium silicates, calcium carbonate and/or calcium oxide, of the first fraction is increased in comparison to the initial calcium content of the starting particulate material before fractioning. In this manner it is possible to adjust the iron oxide and/or calcium contents of the first fraction as well as the second fraction to suit the desired end use. The first fraction, intended for the production of cement clinker in cement kiln may have a low iron oxide content and a high calcium content, and the second fraction, to be used as an active agent in cement or concrete production may have a high iron oxide content. According to one embodiment of the invention, the first fraction may have at least 5 weight-%, preferably at least 15 weight-%, more preferably at least 20 weight-%, lower total iron oxide content than the initial iron oxide content of the starting particulate material before fractioning, calculated from the dry weight. In addition, the first fraction may have at least 3 weight-%, preferably at least 5 weight-%, more preferably at least 7 weight-%, sometimes at least 10 weight-%, higher calcium content than the initial calcium content of the starting particulate material before fractioning.

Thus, after the fractioning the first fraction has a lower iron oxide, i.e. iron(II) and iron(III) content, than the second fraction. The fractioning thus preferably produces a first fraction that is enriched in calcium, such as calcium oxides and/or calcium silicates, but poor in iron oxides. The first fraction, i.e. collected fine non-magnetic particles, contains mainly CaO and Si₂O, which is an excellent starting material for production of cement. The cement raw materials are put into a rotating cement kiln that is heated in stages to up to 1500° C. During this process, the raw materials are converted into typical cement compounds, for example dicalcium silicate (2CaO·SiO₂) and tricalcium silicate (3CaO·SiO₂), tricalcium aluminate (3CaO·Al₂O₃) and tetracalcium-aluminoferrite (4CaO·Al₂O₃·Fe₂O₃). The particulate material preferably comprises calcium, such as calcium oxides and/or calcium silicates, and has an initial calcium content. The first fraction may comprise, for example, particles of alite, belite, merwinite, gehlenite, periclase, mayenite, dolomite and/or calcite. Presence of calcium makes the first fraction especially suitable as feed material for cement clinker production. High content of calcinated material reduces the need for using virgin materials, such as limestone, as feed material for cement kiln and effectively lowers the total CO₂ emissions of the clinker production process. Furthermore, the first fraction contains a decreased amount of metals, such as Fe, Cr, V due to the fractioning, e.g. by magnetic separation. This is beneficial since the fine grinding requires less energy. More importantly, this is beneficial since these metals, especially Cr and V are not wanted in cement kiln.

The starting particulate material used in the invention often comprises chromium, i.e. before fractioning the starting particulate material has an initial chromium content. It has been observed that chromium present in the particulate material is usually associated with iron oxides. This means that when the particulate material is fractioned according to the iron oxide content of the particles into the first fraction and second fraction, at least a part of chromium is transferred to the second fraction together with iron oxides. This means that the chromium content in the first fraction is decreased, whereby less chromium is introduced into the cement kiln in the production process of cement clinker and the formation of harmful Cr(VI) is significantly decreased. According to one embodiment of the invention, the first fraction may have at least 15 weight-%, preferably at least 20 weight-%, more preferably at least 25 weight-%, lower chromium content than the initial chromium oxide content of the starting particulate material before fractioning, given as Cr₂O₃, calculated from the dry weight.

The total chromium content in the first fraction, after fractioning, may be ≤0.5 weight-%, preferably ≤0.3 weight-%, more preferably ≤0.1 weight-%, given as Cr₂O₃, calculated from the dry weight of the first fraction. The total chromium content may be, for example, in a range of 0.05-0.5 weight-%, given as Cr₂O₃, calculated from the dry weight of the first fraction. The total chromium content given as Cr₂O₃ encompasses all oxidation states of chromium. The chromium content varies depending on the used starting particulate material. For example, induction furnaces and electric arc furnaces are often used for production of steel from recycled material where at least part of the chromium is bound to steel and iron oxides.

The first fraction may be comminuted after the fractioning step to a particle size Dv90 of ≤200 μm, preferably ≤100 μm. The first fraction may be comminuted preferably to the particle size Dv90 in a range of 0.01-200 μm, preferably 0.1-100 μm. In this manner the particle size of the first fraction preferably matches the other feed materials fed to the cement kiln and used for production of cement clinker.

General benefits of the present invention and its various embodiments described above are as follows: use of steelmaking slag in valuable products, reduced energy consumption in kiln due to the use of already calcined slag, lower the stack emissions due to lower CO₂ in slag compared to natural raw materials, and improved safety of cement due to lesser hazardous components such as hexavalent chromium. The present invention may thus even enable the use of particulate material originating from industrial pyrometallurgical process as a new feed material for cement production process. It is envisioned that the present method may provide possibility to drastically reduce or even totally eliminate the use of natural resources in cement clinker production and provide CO₂ free production process for cement clinker.

Some embodiments of the invention are described in the following numbered paragraphs:

1. A method for manufacturing materials for cement production, the method comprising
obtaining particulate material comprising a content of iron oxides, and preferably calcium, and originating from an industrial pyrometallurgical process,
fractioning the particulate material into a first fraction and a second fraction, wherein the first fraction has a lower content of iron oxides than the second fraction,
   wherein at least a part of the of the first fraction is used to form a part of a feed material for a production of cement clinker in a cement kiln, and/or
   at least a part of the second fraction is used as a supplementary material for production of cement.

2. The method according to paragraph 1, characterized in that the particulate material is fractioned into the first fraction and the second fraction by using magnetic separation, density separation, size separation, electrostatic separation, flotation or any combination thereof.

3. The method according to paragraph 2, characterized in that the particulate material is fractioned by using a magnetic separation.

4. The method according to paragraph 1, 2 or 3, characterized in that the first fraction has the content of iron oxides of at least 5 weight-%, preferably at least 15 weight-%, more preferably 20 weight-%, less than the content of iron oxides in the particulate material before fractioning.

5. The method according to any of preceding paragraphs 1-4, characterized in that the second fraction has a content of iron oxides of at least 5 weight-%, preferably at least 15 weight-%, more preferably at least 20 weight-%, more than the content of iron oxides in the particulate material before fractioning.

6. The method according to any of preceding paragraphs 1-5, characterized in that the second fraction comprises iron(II) oxide.

7. The method according to any of preceding paragraphs 1-6, characterized in that the particulate material has a particle size Dv50 of <10 mm, preferably <2 mm, more preferably <1.5 mm.

8. The method according to any of preceding paragraphs 1-7, characterized in that the method comprises a pretreatment step, where the material from the industrial pyrometallurgical process is comminuted into the particulate material having a particle size Dv50 of 510 mm, preferably <2 mm, more preferably <1.5 mm, before the fractioning.

9. The method according to paragraph 8, characterized in that the comminuting is performed by using an impact crusher, a high energy impact crusher, a jaw crusher, a cone crusher, a hammer crusher, a roll crusher, a ball mill, a rod mill or any combination of these.

10. The method according to paragraph 8 or 9, characterized in that the pretreatment step comprises separating metallic particles from the comminuted particulate material, preferably by using a magnetic separation and/or size classification.

11. The method according to any of preceding paragraphs 1-10, characterized in that that the particulate material originating from the industrial pyrometallurgical process is selected from ferrous slags, ferroalloy slags, base metal slags, pyrometallurgical tailings, or any of their combinations.

12. The method according to paragraph 11, characterized in that the particulate material is selected from basic oxygen furnace slags, electric arc furnace slags, ladle furnace slags, Linz-Donawitz slags (LD slags), open-hearth furnace slags, blast furnace slags, desulphurization slags or any combinations thereof.

13. The method according to any of preceding paragraphs 1-11, characterized in that an acid, preferably organic acid, is mixed with the second fraction.

14. The method according to paragraph 12, characterized in that the organic acid is selected from oxalic acid, acetic acid, formic acid, citric acid, tartaric acid, or any of their combinations, preferably oxalic acid.

15. The method according to any of preceding paragraphs 1-12, characterized in that the first fraction is comminuted after the fractioning step to a particle size Dv90 of 5200 μm, preferably in a range of 0.01-200 μm and/or the second fraction is comminuted after the fractioning step to a particle size Dv90 of s 30 μm, preferably in a range of 3-30 μm.

An embodiment of the invention relates to a method for manufacturing cement, where the method comprises
obtaining a first fraction comprising particulate material originating from a pyrometallurgical process,
obtaining a second fraction comprising particulate material originating from a pyrometallurgical process,
   wherein the first fraction has a lower iron oxide content than the second fraction, and wherein the first fraction forms a part of a feed material fed into a cement kiln in a production of cement clinker, and
   the second fraction is added as a supplementary material to a cement mix after the cement kiln.

Further embodiments of the invention are described in the following paragraphs:

Embodiment 1 relating to a method of upgrading steelmaking slag, wherein the method comprises:
(a) providing steelmaking slag,
(b) subjecting the steelmaking slag to separation crushing to obtain crushed steelmaking slag,
(c) subjecting the crushed steelmaking slag to at least one magnetic separation step to separate magnetic particles from non-magnetic particles, and collecting said magnetic particles and non-magnetic particles,
(d) subjecting the collected non-magnetic particles to at least one separation step wherein Fe2+ bearing particles are at least partially separated from Fe3+ bearing particles into a Fe2+ bearing particles fraction and a Fe3+ bearing particles fraction, respectively,
(e) optionally subjecting said Fe2+ bearing fraction and/or said Fe3+ bearing mineral fraction particles, respectively, to fine grinding to obtain fine grinded particles of said Fe2+ bearing fraction and/or said Fe3+ bearing mineral fraction, respectively.

Embodiment 2 relating to the method according to embodiment 1, wherein the method further comprises one or more classification step(s) followed by one or more separation step(s) to obtain at least one fine particle fraction with particles with the size of 0-3 mm, preferably 1.5-2.5 mm, before step (d).

Embodiment 3 relating to the method according to embodiments 1 or 2, wherein the separation crushing method is high impact dry crushing.

Embodiment 4 relating to the method according to any embodiment 1-3, wherein the fine grinded particles have a particle diameter of 3 μm to 200 μm.

Embodiment 5 relating to the method according to any embodiment 1-4, wherein a strong magnet is used in at least one magnetic separation step in step (c).

Embodiment 6 relating to the method according to any embodiment 1-5, wherein a weak magnet is used in at least one magnetic separation step in step (c).

Embodiment 7 relating to the method according to any embodiment 1-6, wherein a specific magnet is used in at least one magnetic separation step in step (d) to concentrate the two different grades.

Embodiment 8 relating to the method according to any embodiment 1-7, wherein the steelmaking slag is stainless steel slag, carbon-steel slag, basic oxygen furnace (BOF) slag, electric arc furnace (EAF) slag, ladle furnace (LF) slag, desulphurization slag or any combination thereof.

Embodiment 9 relating to the method according to any embodiment 1-8, wherein the method comprises one or more additional non-magnetic metal separation step(s) to separate heavy and light non-magnetics, wherein non-magnetic separation method is chosen eddy-current separation, gravitational separation and airflow separation.

Embodiment 10 relating to the method according to any embodiment 1-9, wherein the method further comprises using the collected non-magnetic particles directly after magnetic separation or after further fine grinding step (d) as a feed or a part of a feed in cement kiln for manufacturing cement clinkers either directly to the kiln or at a later stage of clinker production.

Embodiment 11 relating to the method according to embodiment 10, wherein one or more additional ingredients chosen from a list comprising; limestone, gypsum, clay, shale, iron ore, bauxite, fly ash, BF slag.

Embodiment 12 relating to the method according to embodiment 9 or 10, wherein the iron content of the feed is adjusted by adding steelmaking slag to the feed.

Embodiment 13 relating to the method according to any embodiment 1-12, wherein the method further comprises using the collected non-magnetic particles directly after the specific concentration (d) or after further fine grinding step (e) as a hexavalent chromium reducing agent for cement.

Embodiment 14 relating to an agent for hexavalent chromium reduction in cement, said agent being obtainable by the method according to any embodiment 1 to 13.

Embodiment 15 relating to a dry concrete premix for making concrete, comprising the agent for hexavalent chromium reduction according to embodiment 14.

Embodiment 16 relating to cement comprising the agent for hexavalent chromium reduction according to embodiment 14.

### BRIEF DESCRIPTION OF THE DRAWINGS

An embodiment is shown in the following schematical drawing, where

FIG. 1 shows a flow diagram exemplifying one embodiment.

FIG. 1 shows one embodiment of the present invention. Material originating from an industrial pyrometallurgical process 1, for example basic oxygen furnace of a steel plant, is subjected to pretreatment comprising a comminution step 2 and a separation step 3. The comminuted material is transferred from the comminution step 2 to a separation step 3. In the separation step 3, the separation may be based on particle size and can be carried out e.g. by sieving or screening. In the separation step 3 coarse particles are separated from the particulate material 4 comprising oxides of iron and having a particle size Dv50 of <2 mm, preferably <1.5 mm. The coarse particles, for example having a particle size Dv50>2.5 mm or >3 mm, are transferred to a partitioning step 9 where the metallic particles 10 are separated from aggregate material 11. The metallic particles 10 can be returned to pyrometallurgical process 1 and the aggregate material 11 can be returned to the comminution step 2.

Particulate material 4 comprising oxides of iron and having a particle size Dv50 of <2 mm is transferred to a fractioning step 5, where the particulate material is divided into a first fraction and a second fraction. The first fraction has a lower iron oxide content than the second fraction. At least a part of the of the first fraction is used to form a part of a feed material for producing cement clinker 8 in a cement kiln 6. At least a part of the second fraction can be used as a supplementary material for producing cement and added to the cement clinker 8 after the cement kiln 6. It is possible to add an organic acid to the second fraction in step 7, before the second fraction is used as supplementary material.

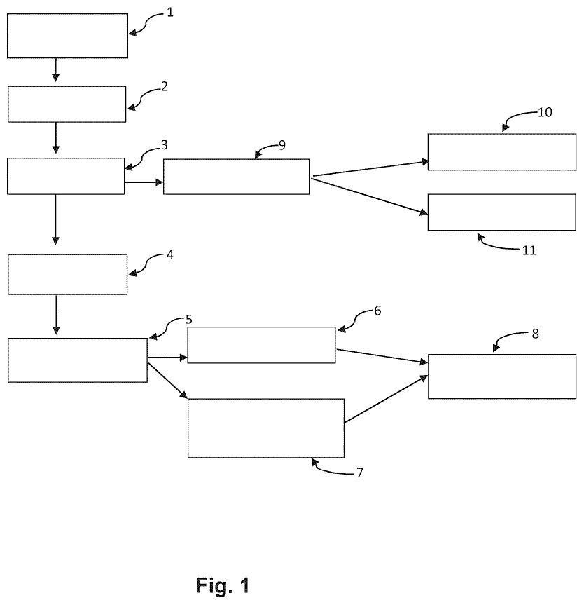

It has been shown that the method here described, particularly features shown as 5, 6, 7 and 8 in FIG. 1, remarkably reduces the content of iron oxides and increases the CaO content in the first fraction thereby improving its usability in production of cement clinker.

### EXPERIMENTAL

Embodiments of the invention are described in the following non-limiting examples.

### Example 1: Effect of Separating Fractions

Steelmaking slag from a European steel plant was subjected to a pretreatment where the steelmaking slag was crushed. Metallic particles and aggregates were separated from the particulate material having particle size Dv50<1 mm, here denoted as demetallized slag. The demetallized slag was magnetically fractioned into a first fraction and second fraction. Table 1 shows the content of the particulate material before fractioning and the content of the first fraction, analysed by using an X-ray fluorescence (XRF) analyzer. All values are given as weight-%.

It can be seen from Table 1 that the iron oxide content in the first fraction is decreased by 20% in comparison to the particulate material before fractioning. It is further seen that the calcium content in the first fraction is increased by 11.5% while there is a 29% decrease in chromium content. The example shows that the content of the first fraction can be modified to form a part of a feed material for producing cement clinker in a cement kiln.

TABLE 1

| | Demetallized slag | First fraction |
|---|---|---|
| LOI* | 1.00 | 1.3 |
| SiO₂ | 13.4 | 14 |
| Al₂O₃ | 2.1 | 2.1 |
| Fe₂O₃** | 25.0 | 20 |
| CaO | 40.3 | 44.9 |
| MgO | 4.8 | 4.5 |
| TiO₂ | 1.4 | 1.4 |
| P₂O₅ | 1.4 | 1.4 |
| Na₂O | 0.1 | 0.1 |
| K₂O | 0.02 | 0.01 |
| Cr₂O₃ | 0.3 | 0.2 |
| SO₃ | 0.2 | 0.2 |
| Cl | 0.02 | 0.02 |

*Loss of ignition
**all iron presented as Fe₂O₃

### Example 2

The ability of steelmaking slag to reduce chromium(VI) to chromium(III) was tested.

Three different steelmaking slags were mixed with Portland cement comprising clinker and gypsum. The compositions of slags are given in Table 2, analysed by using an X-ray fluorescence (XRF) analyzer. All values are given as weight-%.

In some samples oxalic acid was used as proton-donating chemical activator, which was added together with steelmaking slag to the cement sample. The chromium(VI) amount was measured after mixing (initial amount) as well as after 3 and 6 months. Chromium(VI) was determined by using test method DIN EN 196-10:2016. The compositions of the samples and the results are shown in Table 3.

TABLE 2
Compositions of steelmaking slags
used in Example 2 and Example 3.

| | Slag 1 | Slag 2 | Slag 3 | Slag 4 |
|---|---|---|---|---|
| LOI* | 1.27 | 4.47 | 14.85 | — |
| SiO₂ | 13.94 | 25.28 | 16.51 | 12 |
| Al₂O₃ | 2.06 | 6.02 | 2.59 | 7 |
| Fe₂O₃** | 24.28 | 13.28 | 13.65 | 24 |
| CaO | 44.71 | 35.1 | 41.66 | 46 |
| MgO | 5.08 | 7.99 | 3.49 | 3.3 |
| TiO₂ | 1.26 | 0.41 | 0.83 | 1.3 |
| P₂O₃ | 1.44 | 0.38 | 0.43 | 0.65 |
| Na₂O | 0 | 0 | 0 | 0.36 |
| K₂O | 0 | 0.1 | 0.04 | 0.15 |
| Cr₂O₃ | 0.25 | 0.86 | 0.21 | 0.22 |
| Mn₂O₃ | 3.78 | 3.64 | 2.56 | 4 |
| SrO | 0 | 0.03 | 0.02 | 0.02 |
| CuO | 0 | 0.01 | 0.003 | 0 |
| V₂O₅ | 1 | 0.05 | 1.26 | 0.95 |
| ZnO | 0 | 0.03 | 0.02 | 0 |
| ZrO₂ | 0 | 0.02 | 0.06 | 0.01 |
| Nb₂O₅ | 0.04 | 0 | 0.01 | 0.04 |
| In₂O₃ | 0 | 0.96 | 0.92 | 0 |
| SO₃ | 0.62 | 1.12 | 0.71 | 0.25 |
| Cl | 0.04 | 0.11 | 0.08 | — |

*Loss of ignition
**all iron presented as Fe₂O₃

TABLE 3
Compositions of the samples and results of Example 2.

| | | | | | Cr(VI) [ppm] | | |
|---|---|---|---|---|---|---|---|
| | Clinker | Gypsum | Steelslag | Activator | | after 3 | after 6 |
| Sample | [weight-%] | [weight-%] | [weight-%] | [weight-%] | Initial | months | months |
| Reference | 95 | 5 | 0 | 0 | 15.2 | — | — |
| Sample 1 | 90 | 5 | 5 | 1 | 10.1 | 11.8 | 12.0 |
| with Slag 1 | | | | | | | |
| Sample 2 | 90 | 5 | 5 | 0 | 14.2 | — | — |
| with Slag 2 | | | | | | | |
| Sample 2 | 90 | 5 | 5 | 1 | 9.7 | — | 10.3 |
| with Slag 2 | | | | | | | |
| Sample 3 | 90 | 5 | 5 | 1 | 10.0 | 11.8 | 11.4 |
| with Slag 3 | | | | | | | |

It can be seen from the results of Table 3 that the use of steelmaking slag is able to provide initial lowering in chromium(VI) content of cement samples, due to the reduction of chromium(VI) to chromium(III). It can be seen that the obtained effect is intensified, when the steelmaking slag is used in combination with the proton-donating chemical activator. The obtained effect does not significantly fade during 6 months storage.

### Example 3

The ability of steelmaking slag to reduce chromium(VI) to chromium(III) was tested.

Steelmaking slag 4, composition of which is given in Table 2, was mixed with Portland cement comprising clinker and gypsum. Two proton-donating chemical activators were tested: oxalic acid and citric acid. The proton-donating chemical activator was added together with steelmaking slag to the Portland cement.

The chromium(VI) amount of the cement sample was measured after addition of steelmaking slag and the proton-donating chemical activator. Chromium(VI) was determined by using test method DIN EN 196-10:2016.

The compositions of the samples and the results are shown in Table 4.

TABLE 4
Compositions of the samples and results of Example 3.

| | Clinker + | | Oxalic | Citric | |
|---|---|---|---|---|---|
| | Gypsum | Slag | acid | acid | Cr(VI) |
| Sample | [weight-%] | [weight-%] | [%]* | [%] | [ppm] |
| Ref. | 95 | 5 | 0 | 0 | 16.57 |
| #1 | 90 | 5 | 0.5 | | 13.86 |
| #2 | 90 | 5 | 1 | | 12.62 |
| #3 | 90 | 5 | | 0.5 | 15.72 |
| #4 | 90 | 5 | | 1 | 11.34 |

*given of the total cement amount

It can be seen from Table 4 that the reducing effect of the steelmaking slag was increased when the steelmaking slag was used in combination with a proton-donating chemical activator.

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. A particulate material adapted for use as an active agent for reducing chromium(VI) to chromium(III) in manufacture of cement, concrete or the like, wherein the particulate material comprises an industrial pyrometallurgical processed material, and comprises at least 10 weight-% of iron(II) and/or iron(III), given as Fe₂O₃, calculated from a dry weight of the particulate material.

2. The particulate material according to claim 1, wherein the particulate material is combined with a proton-donating chemical activator, preferably an acid.

3. The particulate material according to claim 2, wherein the proton-donating chemical activator is an organic acid or a salt of an organic acid, preferably selected from a group comprising oxalic acid, acetic acid, formic acid, citric acid, tartaric acid, salts thereof or any combinations thereof.

4. The particulate material according to claim 2, wherein the particulate material is combined with 0.1-50 weight-% of the chemical activator, calculated from the total weight of the particulate material.

5. The particulate material according to claim 1, wherein the particulate material comprises iron(II) and/or iron(III) in an amount of ≥15 weight-%, preferably ≥20 weight-%, more preferably ≥30 weight-%, given as Fe₂O₃ and calculated from the dry weight of the particulate material.

6. The particulate material according to claim 1, wherein the particulate material comprises at least 5 weight-%, preferably 10 weight-%, more preferably 15 weight-% of iron(II), calculated as FeO from the dry weight of the particulate material.

7. The particulate material according to claim 1, wherein the particulate material has a particle size Dv90 in a range from 3-200 μm, preferably 3-100 μm, more preferably 3-30 μm.

8. The particulate material according to claim 1, wherein the industrial pyrometallurgical processed material is selected from ferrous slags, ferroalloy slags, base metal slags, pyrometallurgical tailings, or any combinations thereof.

9. The particulate material according to claim 1, wherein the particulate material is a steelmaking slag selected from basic oxygen furnace slags, electric arc furnace slags, ladle furnace slags, Linz-Donawitz slags (LD slags), open-hearth furnace slags, blast furnace slags, desulphurization slags or any combinations thereof.

10. A method for reducing chromium(VI) to chromium(III) in a manufacture of cement, concrete or the like, the method comprising:
obtaining a particulate material originating from an industrial pyrometallurgical process, preferably from a steelmaking process, the particulate material comprising at least 10 weight-% of iron(II) and/or iron(III), given as Fe₂O₃, and calculated from the dry weight of the particulate material, and preferably 5 weight-% or less, more preferably 3 weight-% or less, of Fe(0), and
adding the particulate material as an active agent to a cement mix, concrete mix or the like for reducing chromium(VI) to chromium(III).

11. The method according to claim 10, wherein a proton-donating chemical activator is brought into contact with the particulate material.

12. The method according to claim 11, wherein the proton-donating chemical activator is mixed with the particulate material before the addition of the particulate material to the cement mix, concrete mix or the like.

13. The method according to claim 11, wherein the proton-donating chemical activator is added separately from the particulate material to the cement mix, concrete mix or the like.

14. A method for manufacturing a particulate material, adapted for use as an active agent for reducing chromium(VI) to chromium(III) in a manufacture of cement, concrete or the like, the method comprising:
obtaining a starting particulate material originating from an industrial pyrometallurgical process, preferably from a steelmaking process, starting the particulate material comprising iron(II) and/or iron(III), and
fractioning the starting particulate material into at least a first fraction and a second fraction, wherein the first fraction and the second fraction have different content of iron(II) and iron(III), and the second fraction is a particulate material comprising at least 10 weight-% of iron(II) and/or iron(III), given as Fe₂O₃ and calculated from the dry weight of the particulate material, and preferably 5 weight-% or less, more preferably 3 weight-% or less, of Fe(0).

15. The method according to claim 14, wherein the starting particulate material is fractioned into the first fraction and the second fraction by using magnetic separation, density separation, size separation, electrostatic separation, flotation separation, eddy-current separation, gravitational separation and airflow separation, or any combination thereof, preferably by using a magnetic separation.

16. The method according to claim 14, wherein the second fraction is subjected to comminuting to obtain fine grinded particles, preferably having a particle size Dv90 in a range from 3-200 μm, preferably 3-100 μm, more preferably 3-30 μm.

17. The particulate material according to claim 1, wherein the industrial pyrometallurgical processed material comprises a steelmaking processed material.

18. The particulate material according to claim 1, wherein the material comprises 5 weight-% or less of Fe(0).

19. The particulate material according to claim 1, wherein the material comprises 3 weight-% or less, of Fe(0).
